(19) United States
(12) Patent Application Publication
(10) Pub. No.: US 2013/0169746 A1
(43) Pub. Date: Jul. 4, 2013

(54) Conference Recording Device and the Method Thereof

(71) Applicant: TRANSPAC CORPORATION, Tokyo City (JP)

(72) Inventor: ENATSU IHO, TOKYO City (JP)

(73) Assignee: TRANSPAC CORPORATION, Tokyo (JP)

(21) Appl. No.: 13/730,826

(22) Filed: Dec. 28, 2012

(30) Foreign Application Priority Data
Jan. 3, 2012 (TW) 101100225

(51) Int. Cl. H04N 5/232

(52) U.S. Cl. CPC H04N 5/23238
USPC 348/37; 348/36

(57) ABSTRACT

A conference recording device includes a panoramic camera device. The panoramic camera device is disposed on a table surface. The panoramic camera device has a first view plane formed at one side of the table surface, wherein the first view plane intersects with the horizontal plane of the panoramic camera at an acute angle. A conference recording method includes: retrieving image information of the panoramic camera, analyzing the image information to produce a comparison result, adjusting the image information to produce a corrected image, and receiving the comparison result and the corrected image by a display module. When the comparison result shows that a speaker is changed, the display module outputs the corrected image of the speaker.

### BACKGROUND OF THE INVENTION

1. Field of the Invention

The present invention relates to a recording device; particularly, the present invention relates to a conference recording device applied to software or hardware systems utilized in a video conference.

2. Description of the Prior Art

Video conference systems nowadays can be classified in three types: a fixed camera, a rotating camera which rotates in horizontal and vertical directions, and a camera disposed on the ceiling to record the attendees and facilitate real-time communications through video and audio methods. The fixed camera, such as a web camera, requires to adjust the position of lens continuously to track the movement of the attendees, so the conference will be likely interrupted. The rotating camera may automatically track and record a speaker based on the positioning of the speaker, but the rotating camera cannot record activities or facial expressions of other attendees at the same time; as for a host, the control of conference will be diminished. The ceiling camera cannot record the activities of attendees in the horizontal direction and cannot clearly capture face characters thereof.

FIG. 1 is a schematic view of the image captured by the traditional conference recording device. As shown in FIG. 1, because of the limited viewing angle, activities of the attendees are recorded but their face characters cannot be clearly captured by the traditional conference recording device, so that the face characters of the attendees are not easy to be identified. Besides, the viewing angle of the traditional conference recording device is flat, so that the traditional conference recording device cannot clearly record activities of the attendees in the horizontal direction. If other types of recording devices mentioned above are adopted, the number of the conference recording devices must be increased, not only increasing the cost, but also increasing the loading the video conference system.

### SUMMARY OF THE INVENTION

It is an object of the present invention to provide a conference recording device that can clearly capture the front side of physical characteristics.

A conference recording device includes a panoramic camera device. The panoramic camera device is disposed on a table surface. The panoramic camera device has a first view plane formed at one side of the table surface and the first view plane intersects with the horizontal plane of the first position at an acute angle or a right angle.

A conference recording method includes: retrieving image information of the panoramic camera device, analyzing the image information in the storage unit and the image information presently captured by the panoramic camera device to produce a comparison result, adjusting the image information presently captured by the panoramic camera device to produce a corrected image, and receiving the comparison result and the corrected image by a display module. When the comparison result shows the change of a speaker, the display module outputting the corrected image corresponding to the change of the speaker.

### BRIEF DESCRIPTION OF THE DRAWINGS

FIG. 1 is a schematic view of the image captured by the traditional conference recording device;

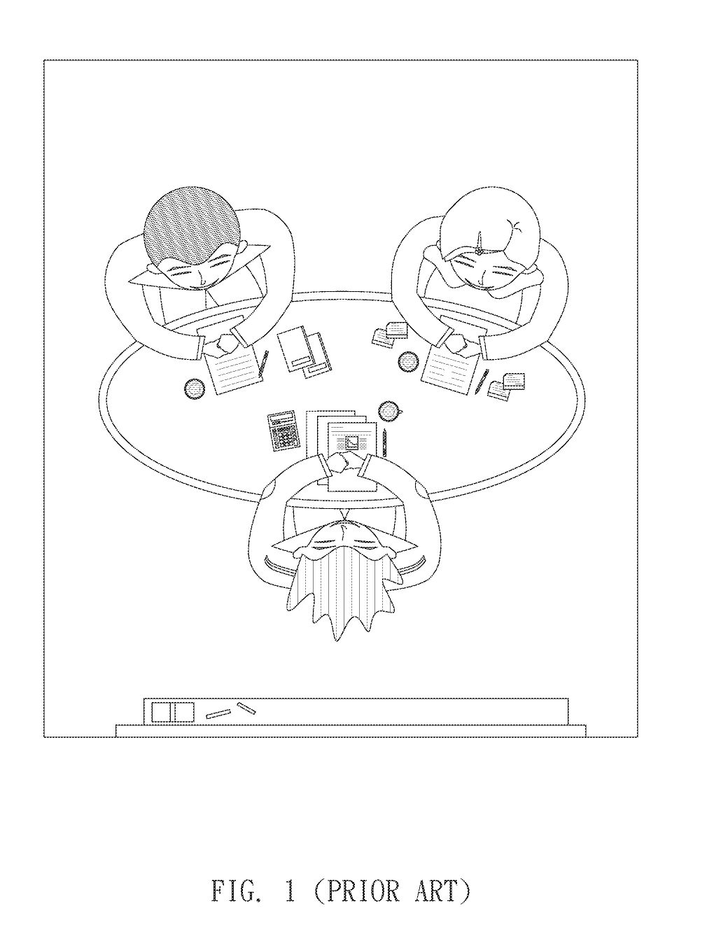

FIG. 2A is a side view of a conference recording device of the present invention;

FIG. 2B is a top view of the conference recording device of the present invention;

FIG. 3A is a schematic view of an embodiment of the conference recording device of the present invention;

FIG. 3B is a schematic view of the image captured by the conference recording device of the present invention;

FIG. 3C is a schematic view of the image corrected by the conference recording device;

FIG. 4A is a schematic view of the conference recording device of the present invention;

FIG. 4B is a flow chart of the conference recording method of the present invention.

### DETAILED DESCRIPTION OF THE PREFERRED EMBODIMENT

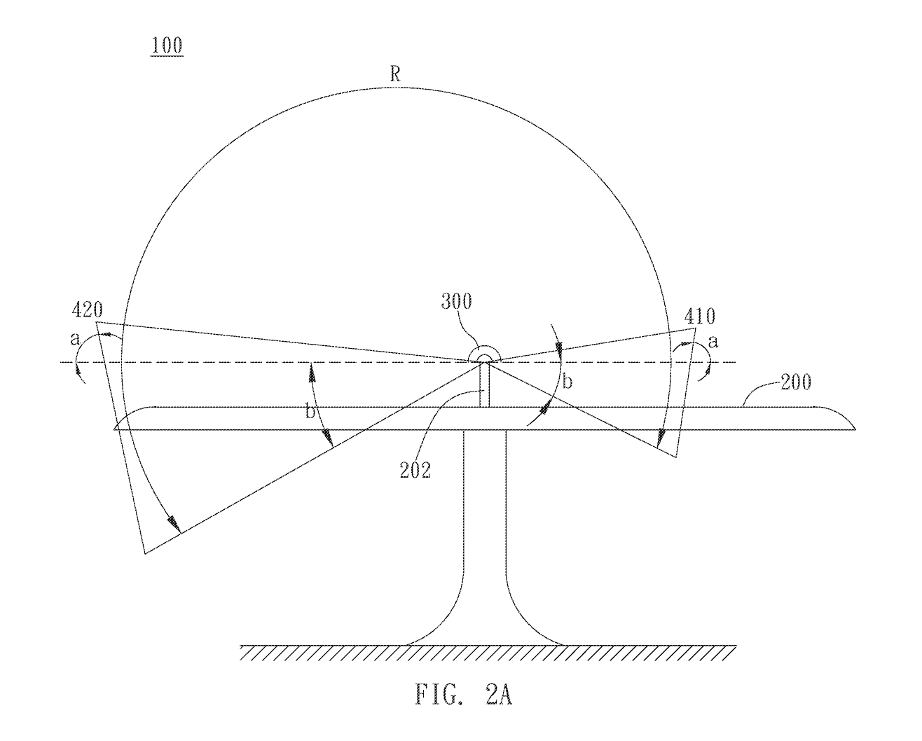

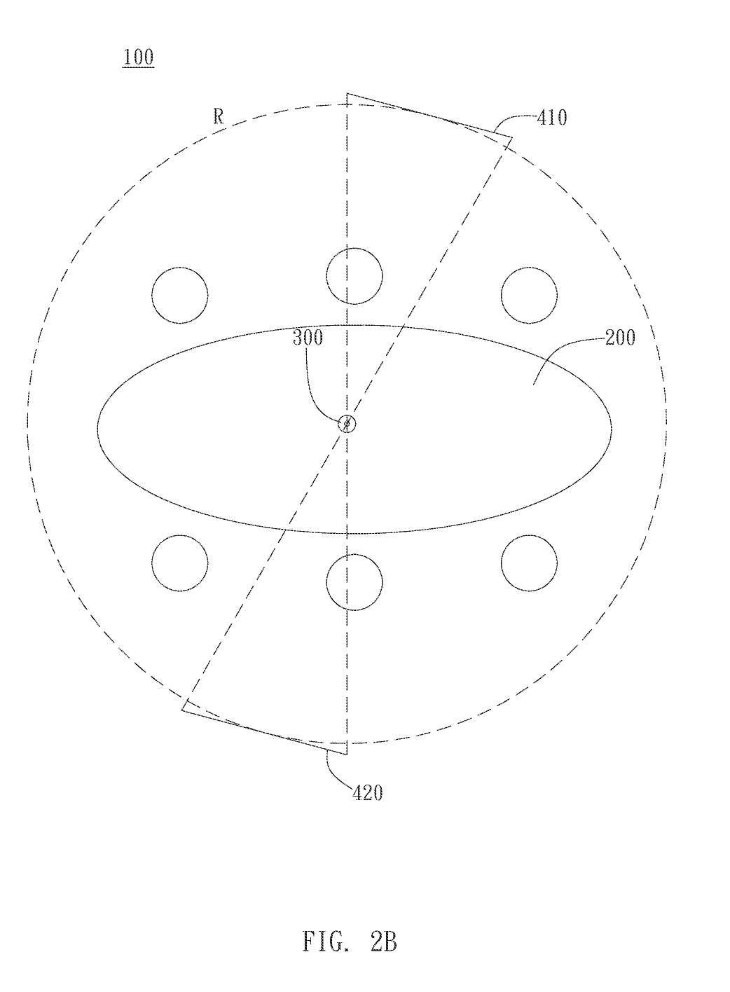

The present invention provides a conference recording device 100. FIG. 2A is a side view of a conference recording device of the present invention. As shown in FIG. 2A, the conference recording device 100 is a panoramic camera device 300 which is installed on the table surface 200 by an arm 202. The conference recording device 100 has a first view plane 410 formed at one side of the table surface 200, wherein the first view plane 410 is perpendicular to or intersects with the horizontal plane of the panoramic camera device 300 at an angle (a). With respect to the horizontal plane, the angle (a) is an acute angle larger than or equal to the 45 degrees so as to clearly record the front side of physical characteristics, such as human body. On the other hand, the panoramic camera device 300 has a second view plane 420, which is formed at another side of the table surface 200 and opposite to the first view plane 410. Similarly, the second view plane 420 is perpendicular to or intersects with the horizontal plane of the panoramic camera device 300 at an angle (a), which is an acute angle with respect to the horizontal plane. In addition, a depression angle (b) exists between the horizontal plane of the panoramic camera device 300 and the first view plane 410 or between the horizontal plane and the second view plane 420, that is, the depression angle (b) ranges between the horizontal plane and the lowest position of the first view plane 410 or between the horizontal plane and the lowest position of the second view plane 420. Please also refer to the top view of the conference recording device 100 shown in FIG. 2B; the panoramic camera device 300 has a viewing range (R) formed by encircling 360 degrees of the first view plane 410 or the second view plane 420 around the panoramic camera device 300. In particular, the viewing range (R) includes the first view plane 410, the second view plane 420, and a region between the first view plane 410 and the second view plane 420, wherein the viewing range (R) is larger than 180 degrees. That is, the visual field of the camera device 300 includes the space above the horizontal plane of the panoramic camera 300 and the region outwardly extending from the depression angle (b). The panoramic camera device 300 may take images in wide viewing angle or utilize fisheye lens to obtain a panorama image. The conference recording device 100 utilizes the first view plane 410 or the second view plane 420 to face the front side of physical characteristics so as to avoid image distortions, which results in unrecognizable facial and body features when the viewing angle is too large. For example, the ceiling camera device in prior arts involves problems such as flat viewing angle and obscure features. Besides, the conference recording device 100 of the present invention may record all attendees without continuously changing the location of the lens.

The panoramic camera device 300 may take images of target objects around the table surface 200 through the first view plane 410 and the second view plane 420. In order to obtain the relation between the panoramic camera device 300 and the target objects, it may consider the resolution of the panoramic camera device 300 and ratio of total pixels, as shown in Table 1.

TABLE 1

| | Analog | | | |
|---|---|---|---|---|
| Type | camera D1 | 2 megapixels | 3 megapixels | 5 megapixels |
| Resolution | 720 × 480 | 1,920 × 1,080 | 2,048 × 1,536 | 2,592 × 1,944 |
| Total | 345,600 | 2,073,600 | 3,145,728 | 5,038,848 |
| pixels | | | | |
| ratio of | 1 | 6 | 9.10 | 14.58 |
| total | | | | |
| pixels | | | | |

As shown in Table 1, the number of total pixels is increased by a multiple factor when the panoramic camera device 300 having resolution of megapixels is adopted. Because the target object has a width and a length, the square root of the ratio of total pixels can be defined as the magnification, which in each case is √6=2.45, √9=3, √14.58=3.82 that can be rounded to an integral to obtain the magnification of 1, 2, 3, 4. By means of the aforementioned panoramic camera devices 300, a specific part of the target object shown in digital magnification will obtain the magnification of 2.45×, 3.01×, and 3.82× while maintaining the same unit resolution (total pixels/area).

On the other hand, in order to get the effective distance, reference is made to the relation of viewing angle and focal length of the optical lens. Taking ⅓ inch analog camera lens as example, the relation of focal length and viewing angle is shown in Table 2.

TABLE 2

Focal length

| | 4 mm | 8 mm | 12 mm | 16 mm |
|---|---|---|---|---|
| Viewing angle | 70° | 40° | 30° | 20° |
| magnification | 1x | 2x | 3x | 4x |

It is assumed that the width of the target object is 7 m, the calculations are given as:

(7/2)/tan(70°/2)=3.5/0.700=5.00(viewing distance(m))

(7/2)/tan(40°/2)=3.5/0.363=9.64(viewing distance(m))

(7/2)/tan(30°/2)=3.5/0.267=13.10(viewing distance(m))

(7/2)/tan(20°/2)=3.5/0.176=19.88(viewing distance(m))

That is, if the width of the target object is maintained at 7 m, then the viewing distance increases as the focal length of the optical lens increases. Based on the above calculations, after the magnification of the high resolution panoramic camera device 300 is compared with the magnification of the optical lens, the relation of magnification and viewing distance (round up to the integral) of the panoramic camera device 300 is shown in Table 3. Based on Table 1 and Table 2, it can be derived that using a high resolution panoramic camera device 300 may substitute the zooming method of optical lens to achieve the partial enlargement function, as shown in Table 3.

TABLE 3

| | Analog | | | |
|---|---|---|---|---|
| Type | camera D1 | 2 megapixels | 3 megapixels | 5 megapixels |
| magnification | 1x | 2x | 3x | 4x |
| Viewing distance | 5 | 10 | 13 | 20 |

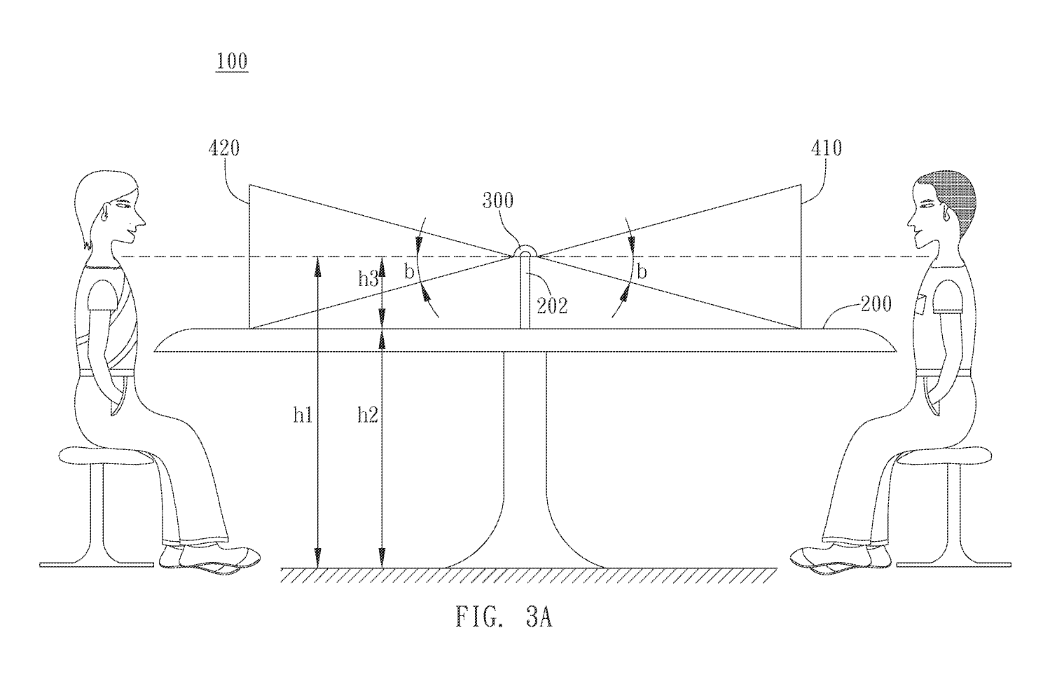

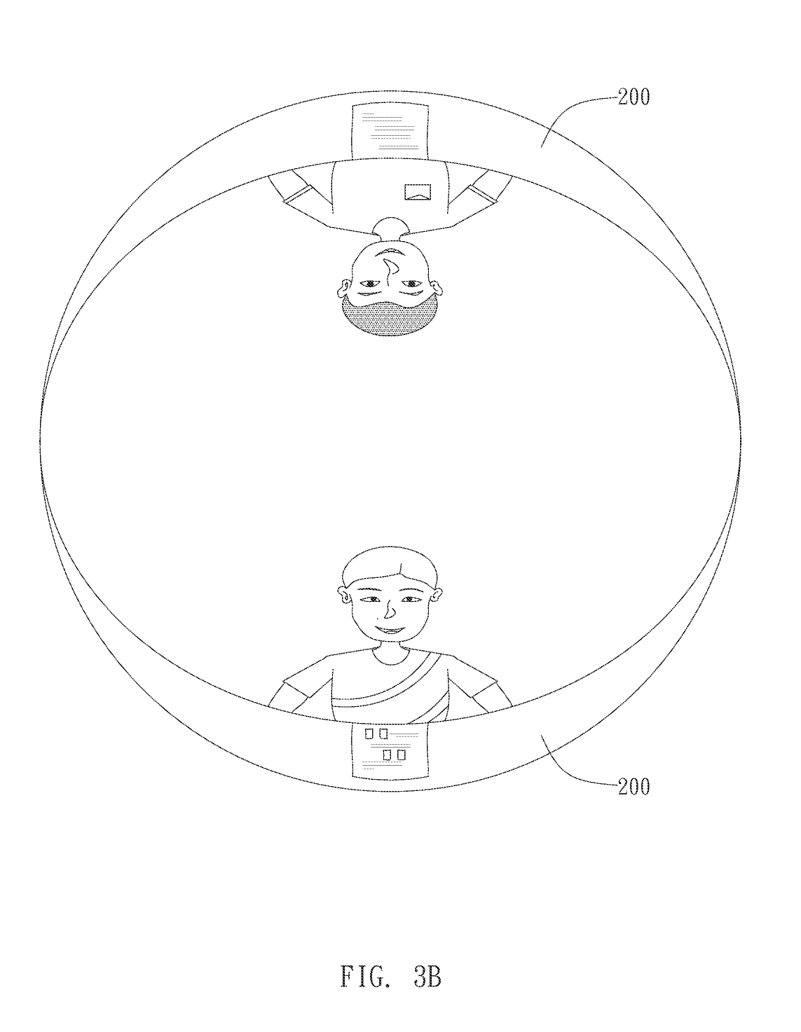

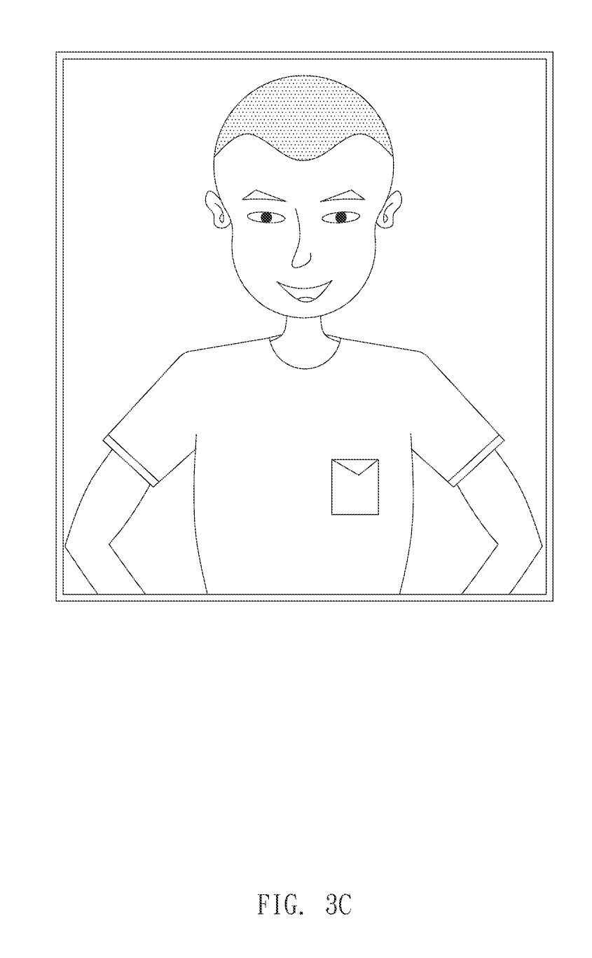

Please refer to FIGS. 3A and 3B. FIG. 3A is a schematic view of an embodiment of the conference recording device 100 of the present invention; FIG. 3B is a schematic view of the image captured by the conference recording device 100 of the present invention. As shown in FIG. 3A, the panoramic camera device 300 is disposed by the arm 202 perpendicular to the table surface 200. The panoramic camera device 300 has a height h1 relative to the bottom of a table having the table surface 200 or the ground on which the table is disposed. The table surface has a height h2 and the depression angle (b) exists between the first view plane 410 and the horizontal plane of the panoramic camera device 300. In addition, the height difference between the panoramic camera device 300 and the table surface 200 is a height difference h3. As shown in FIG. 3A, it is assumed that height h1=1.5 m, height h2=1 m, and the depression angle (b) is 17°. Therefore, the height difference h3 is 0.5 m (h3=1.5 m−1 m=0.5 m) and the nearest viewing distance of an upper body is given as:

tan(90°−17°)×0.5 m=1.64 m.

If height h1=2 m, height h2=1 m, and the depression angle (b) is 17°, then the height difference h3 is 1 m and the nearest viewing distance of an upper body is given as:

tan(90°−17°)×1 m=3.27 m.

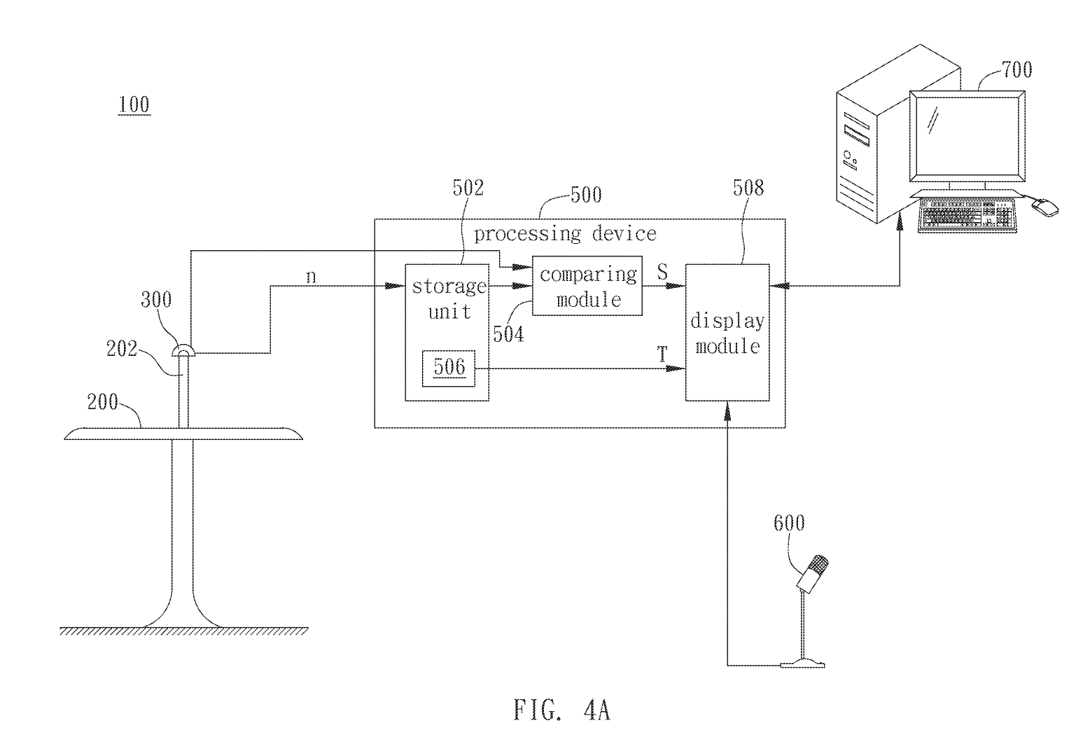

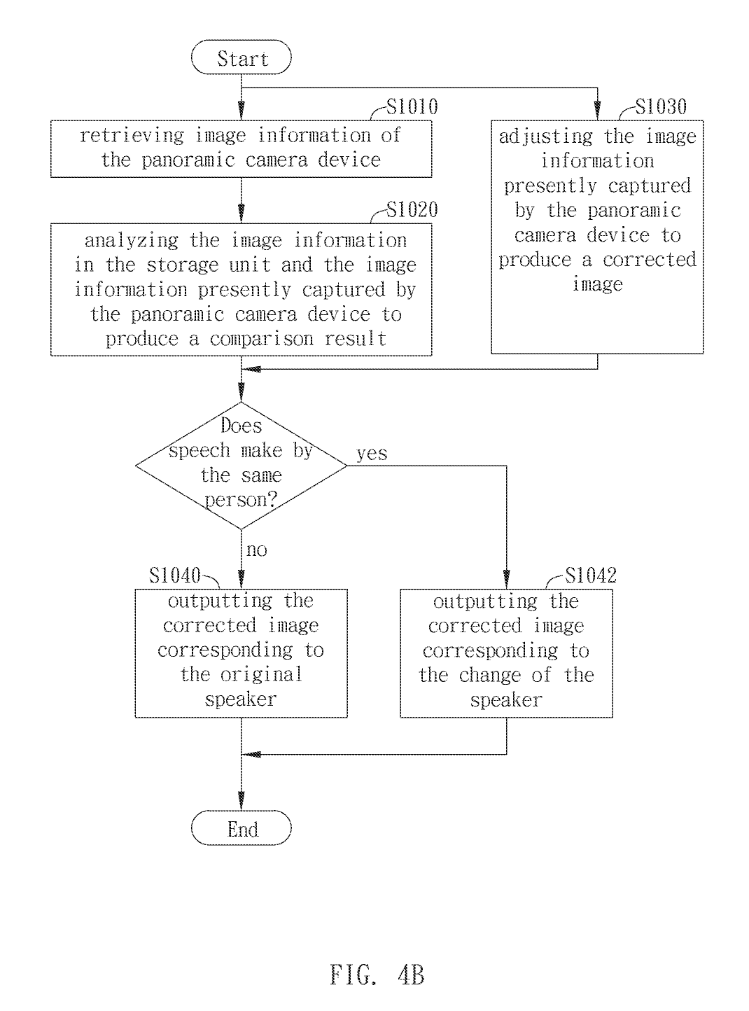

When the panoramic camera device 300 is disposed with a height of 1.5 m, the viewing distance of the upper body is larger than 1.64 m; when the panoramic camera device 300 is disposed with a height of 2 m, the viewing distance of the upper body is larger than 3.27 m. The captured image of the upper body is corrected as shown in FIG. 3C. As shown in FIG. 3C, the corrected image of an upper body may further be switched to the face expression of the speaker. The image correction may further refer to descriptions related to FIG. 4B. The aforementioned depression angle (b) is preferably smaller than 45 degrees to take a clear image and may be adjusted according to the installation position. Users may adjust the arm 202, which is connected between the panoramic camera device 300 and the table surface 200, to obtain different height h1 and get a required viewing distance. For example, the panoramic camera device 300 may be disposed directly on the table surface 200 or may be embedded into the video conference system, such as a monitor, a projector, or other software/hardware equipments. The panoramic camera device 300 may be disposed in a range of 2 m above the bottom of the table surface 200 and takes the depression angle (b) preferably smaller than 45 degrees to get a clear image. With the panoramic camera device 300 of the present invention, the physical character of the captured image is easy to identify and the problem of flat viewing angle is improved. In addition, the panoramic camera device 300 has higher mobility and it does not require manual adjustment. Furthermore, the panoramic camera device 300 can record all attendees at the same time, so that the number of the panoramic camera devices 300 may be decreased to save cost.

FIG. 4A is a schematic view of the conference recording device 100 of the present invention. As shown in FIG. 4A, the conference recording device 100 has a processing device 500 connected to the panoramic camera device 300. The processing device 500 includes a storage unit 502, a comparing module 504, a correction module 506, and a display module 508. The storage unit 502 retrieves image information (n) of the panoramic camera device 300. The comparing module 504 obtains the image information (n) from the storage unit 502 and analyzes the image information (n) to produce a comparison result (S). For example, the storage unit 502 can have particular preset information such as expressions and movement of the speaker to compare with the image information (n) of the panoramic camera device 300. The correction module 506 obtains the image information (n) presently captured by the panoramic camera device 300 and adjusts the image information (n) to produce a corrected image (T). The display module 508 receives the comparison result (S) and the corrected image (T). When the comparison result (S) shows the change of a speaker, the display module 508 outputs the corrected image (T) to a display device 700 or outputs the corrected image corresponding to the speaker by the display module 508 based on an external audio signal from the microphone 600. Besides, the display device 700 may directly search the comparison result (S) and the corrected image (T) in the display module 508. For example, when there are multiple speakers communicating at the same time, the corrected image (T) of speakers may be presented by split-screens on the display device 700. In addition, the processing device 500 may record image information (n) and external audio signal by wire or wireless method. The processing device 500 may be disposed apart from the conference recording device 100 and will not be limited by space.

The practical workflow mentioned above is shown in FIG. 4B. The conference recording method includes step S1010: retrieving image information of the panoramic camera device. The storage unit retrieves image information of the panoramic camera device and then outputs image information to the comparing module and the correction module. Step S1020 involves analyzing the image information in the storage unit and the image information presently captured by the panoramic camera device to produce a comparison result. The storage unit can have particular preset information such as expressions and movement to compare with the image information of the panoramic camera device. Step S1030 involves adjusting the image information presently captured by the panoramic camera device to produce a corrected image. Then the display module receives the comparison result and the corrected image. When the comparison result shows the same speaker, step S1040 involves that the display module outputs the corrected image corresponding to the original speaker. When the comparison result shows the change of a speaker, step S1042 involves that the display module outputs the corrected image corresponding to the change of the speaker. Besides, the display module may receive an external audio signal and outputs the corrected image corresponding to the speaker.

With the conference recording device 100 of the present invention, the pictures may be corrected by digital computing software and be presented in various split-screens. The encircling recording image of the conference recording device 100 of the present invention is suitable for image analysis technology to detect physical characters, movement, and can indicate the location of the speaker or present images of different speakers by split-screens.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A conference recording device disposed on a table surface, comprising:
a panoramic camera device disposed on the table surface, the panoramic camera device having a first view plane formed at one side of the table surface; wherein the first view plane intersects with a horizontal plane of the panoramic camera device at a right angle or an acute angle.

2. The conference recording device of claim 1, wherein the panoramic camera device has a second view plane formed at the other side of the table surface opposite to the first view plane, the second view plane intersects with the horizontal plane of the panoramic camera device at a right angle or an acute angle, wherein the panoramic camera device has a viewing range including the first view plane, the second view plane, and a region between the first view plane and the second view plane, wherein the viewing range is larger than 180 degrees.

3. The conference recording device of claim 2, wherein the acute angle between the horizontal plane of the panoramic camera device and the first view plane or between the horizontal plane of the panoramic camera device and the second view plane is equal to or larger than 45 degrees.

4. The conference recording device of claim 2, wherein the viewing range is formed by encircling 360 degrees of the first view plane or the second view plane around the panoramic camera device.

5. The conference recording device of claim 2, wherein a depression angle exists between the horizontal plane of the panoramic camera device and the lowest position of the first view plane or between the horizontal plane of the panoramic camera device and the lowest position of the second view plane is equal to or smaller than 45 degrees.

6. The conference recording device of claim 1, wherein the height of the panoramic camera device relative to a bottom of a table having the table surface is less than 2 meters.

7. The conference recording device of claim 1, further comprising an arm disposed perpendicular to the table surface to connect the panoramic camera device with the table surface.

8. The conference recording device of claim 1, wherein the panoramic camera device is embedded in a video conference system.

9. The conference recording device of claim 1, further comprising a processing device connected to the panoramic camera device, the processing device comprising a storage unit retrieving image information of the panoramic camera device.

10. The conference recording device of claim 9, wherein the processing device further comprises a comparing module obtaining the image information from the storage unit and analyzing the image information to produce a comparison result.

11. The conference recording device of claim 9, wherein the processing device further comprises a correction module obtaining the image information from the storage unit and adjusting the image information to produce a corrected image.

12. A conference recording method utilized in the conference recording device of claim 1, comprising:
retrieving image information of the panoramic camera device by a processing device;
analyzing the image information in the storage unit and the image information presently captured by the panoramic camera device to produce a comparison result; and
adjusting the image information presently captured by the panoramic camera device to produce a corrected image.

13. The conference recording method of claim 12, further comprising:
receiving the comparison result and the corrected image by a display module; and when the comparison result shows the same speaker, the display module outputting the corrected image corresponding to the original speaker; when the comparison result shows the change of a speaker, the display module outputting the corrected image corresponding to the change of the speaker.

14. The conference recording method of claim 13, wherein the outputting step comprises:
receiving an external audio signal and outputting the corrected image corresponding to the speaker by the display module.
